(19) United States
(12) Patent Application Publication
(10) Pub. No.: US 2011/0168522 A1
(43) Pub. Date: Jul. 14, 2011

(54) CURRENCY DISCRIMINATING DEVICE

(75) Inventor: Eiki Wakabayashi, Isesaki-shi (JP)

(73) Assignee: SANDEN CORPORATION, Isesaki-shi (JP)

(21) Appl. No.: 13/063,386

(22) PCT Filed: Sep. 14, 2009
(86) PCT No.: PCT/JP2009/066466

§ 371 Date: Mar. 10, 2011

(30) Foreign Application Priority Data
Sep. 30, 2008 (JP) 2008-252100

(51) Int. Cl. G07D 7/00

(52) U.S. Cl. 194/302

(57) ABSTRACT

Provided is a currency discriminating device that can reduce a possibility of accepting a counterfeit currency, and that can suppress the reduction of sales opportunities due to the insertion of the counterfeit currency. The currency discriminating device includes: a denomination discriminating device that determines authenticity and denomination of an inserted currency; a coin sorting device that accepts the inserted currency determined to be genuine by the denomination discriminating device, and that returns the inserted currency determined to be counterfeit by the denomination discriminating device; and a control device that changes to an acceptance prohibiting mode in which the coin sorting device is controlled so as to return a following inserted currency if the inserted currency is determined to be counterfeit by the denomination discriminating device in a normal mode, and that controls the coin sorting device so as to return the inserted currency and changes to the normal mode if the inserted currency is determined to be genuine by the denomination discriminating device in the acceptance prohibiting mode.

### TECHNICAL FIELD

The present invention relates to a currency discriminating device used for vending machines, etc.

### BACKGROUND ART

Conventionally, as this kind of currency discriminating device, there has been known a device including: discriminating means that determines authenticity and denomination of an inserted currency; currency sorting means that accepts the inserted currency determined to be genuine by the discriminating means, and that returns the inserted currency determined to be counterfeit by the discriminating means; and control means that controls the discriminating means and the currency sorting means.

By the way, determination processing of the inserted currency by the discriminating means is not always perfectly successful and, for example, when a counterfeit currency is continuously inserted, the counterfeit currency is accepted as a genuine one in some cases.

Consequently, there has been known a currency discriminating device including: a timer that measures time from a time of currency insertion if an inserted currency is determined to be counterfeit by the discriminating means; and currency acceptance prohibiting means that prohibits acceptance of a following currency if the timer operates (for example, refer to Patent Document 1).

In this currency discriminating device, if the inserted currency is determined to be counterfeit, acceptance of a following inserted currency is prohibited regardless of being genuine or counterfeit until a predetermined time elapses after the counterfeit currency is returned, whereby an acceptance rate of the counterfeit coin due to continuous insertion of the currency can be reduced.
Patent Document 1: Japanese Patent Publication 3634562

### DISCLOSURE OF THE INVENTION

### Problems to be Solved by the Invention

However, in the above-described conventional example, even when a genuine coin is inserted within the above-described predetermined time, the currency is not accepted, and thus, for example, when the currency discriminating device is provided in a vending machine, products cannot be sold within the time, and there has been a possibility that sales opportunities decrease to reduce convenience.

The present invention is made in view of the above situation, and an object thereof is to provide a currency discriminating device that can reduce a possibility of accepting a counterfeit currency, and that can suppress the reduction of sales opportunities due to the insertion of the counterfeit currency.

### Means for Solving the Problems

In order to achieve the above-described object, in a currency discriminating device of the present invention including: discriminating means that determines authenticity and denomination of an inserted currency; currency sorting means that accepts the inserted currency determined to be genuine by the discriminating means, and that returns the inserted currency determined to be counterfeit by the discriminating means; and control means that controls the discriminating means and the currency sorting means, if the inserted currency is determined to be counterfeit by the discriminating means in a normal mode, the above-described control means changes to an acceptance prohibiting mode that controls the currency sorting means so as to return a following inserted currency, and if the inserted currency is determined to be genuine by the discriminating means in the acceptance prohibiting mode, the means controls the currency sorting means so as to return the inserted currency, and changes to the normal mode.

As a result of this, if the inserted currency is determined to be genuine in the acceptance prohibiting mode, the inserted currency is returned and the mode is changed to the normal mode, and thus it becomes possible to immediately accept the genuine currency, for example, as compared with a case where acceptance of the inserted currency is prohibited until the predetermined time elapses after the mode is changed to the acceptance prohibiting mode.

### Advantages of the Invention

As explained above, according to the present invention, the genuine currency can be immediately accepted, for example, as compared with the case where acceptance of the inserted currency is prohibited until the predetermined time elapses after the mode is changed to the acceptance prohibiting mode, thus enabling to suppress the reduction of sales opportunities to improve convenience. In addition, since the inserted currency is returned in the acceptance prohibiting mode, a possibility of accepting the counterfeit currency due to continuous insertion of the currency can be reduced.

### BRIEF DESCRIPTION OF THE DRAWINGS

FIG. 1 is a schematic configuration view of a currency discriminating device showing one embodiment of the present invention;

FIG. 2 is a functional block diagram of a control device; and

FIG. 3 is a flow chart illustrating operations when a currency is inserted.

### DESCRIPTION OF SYMBOLS

1 Currency discriminating device
2 Coin
20 Denomination discriminating device
30 Coin sorting device
100 Control device
110 Control section

### BEST MODE FOR CARRYING OUT THE INVENTION

Hereinafter, modes for carrying out the present invention will be specifically described based on drawings.

### Embodiment

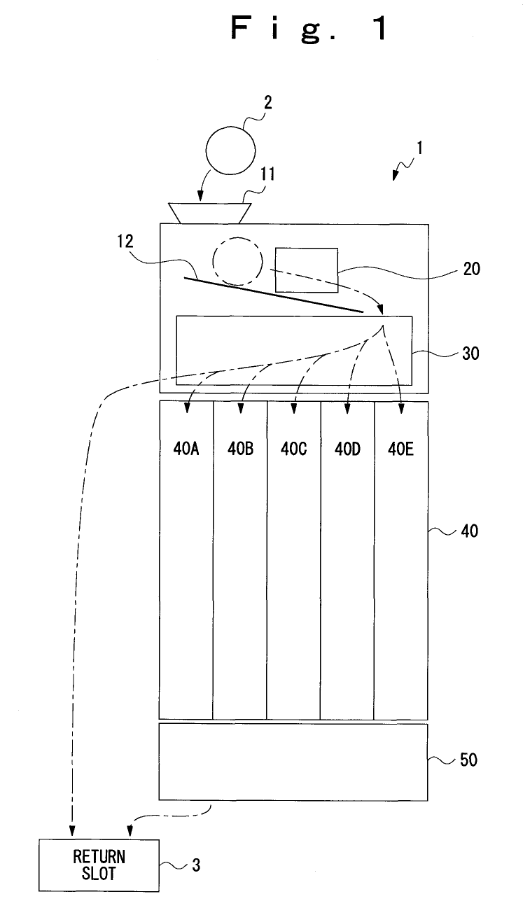

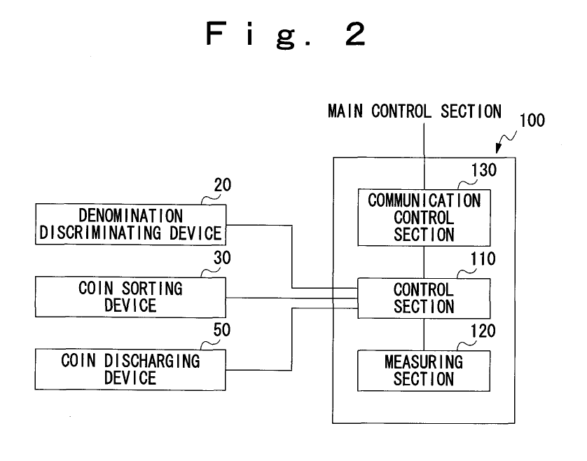

First, a configuration of a currency discriminating device will be described with reference to FIGS. 1 and 2. A currency discriminating device 1 of the embodiment is provided in vending machines etc., and as shown in FIG. 1, it includes: a slot 11 of a coin 2 as a currency; a coin guiding path 12 through which the coin 2 inserted from the slot 11 is guided; a denomination discriminating device 20 as discriminating means that determines authenticity and denomination of the coin 2 passing through the coin guiding path 12; a coin sorting device 30 that sorts the coin 2 having passed through the coin guiding path 12 into a returning-side path or each path of each accepted denomination; a coin stacking cylinder 40 in which the coin 2 sorted by the coin sorting device 30 is stacked; a coin discharging device 50 that discharges the coin 2 stacked in the coin stacking cylinder 40; and a control device 100 (not shown in FIG. 1). It is to be noted that since configurations of the slot 11, the coin guiding path 12, the denomination discriminating device 20, the coin sorting device 30, the coin stacking cylinder 40, and the coin discharging device 50 are similar to those of conventional ones, a detailed description is omitted here.

The coin stacking cylinder 40 is comprised of a plurality of tubes 40A to 40E formed for every denomination. The coin sorting device 30 operates based on a instruction from the control device 100, and sorts the inserted coin 2 into a predetermined return slot 3 or a safe (not shown) if needed, as well as sorting the inserted coin 2 into each tube 40A to 40E of the coin stacking cylinder 40.

Next, the control device 100 will be described with reference to a functional block diagram in FIG. 2. As shown in FIG. 2, the control device 100 includes a control section 110, a measuring section 120, and a communication control section 130.

The control section 110 is comprised of a computer including a CPU, a RAM, a ROM, etc., and controls each device. In addition, in the RAM of the control section 110, provided is a region for a counter whose value increases if a coin 2 newly inserted within a predetermined time (for example, 5 seconds) after the coin 2 is inserted is determined to be counterfeit by the denomination discriminating device 20. It is to be noted that an initial value of the counter is 0, and a value thereof is indicated as a natural number. Further, the control section 110 is configured to shift two modes, i.e., a normal mode and an acceptance prohibiting mode, and to thereby make the currency discriminating device 1 operate. Here, the acceptance prohibiting mode means a state where a following inserted coin 2 is returned from the return slot 3 regardless of authenticity of the coin 2.

The measuring section 120 is a well-known timer, and measures time based on the control by the control section 110. The communication control section 130 is the section for communicating with a main control section of a vending machine body, etc.

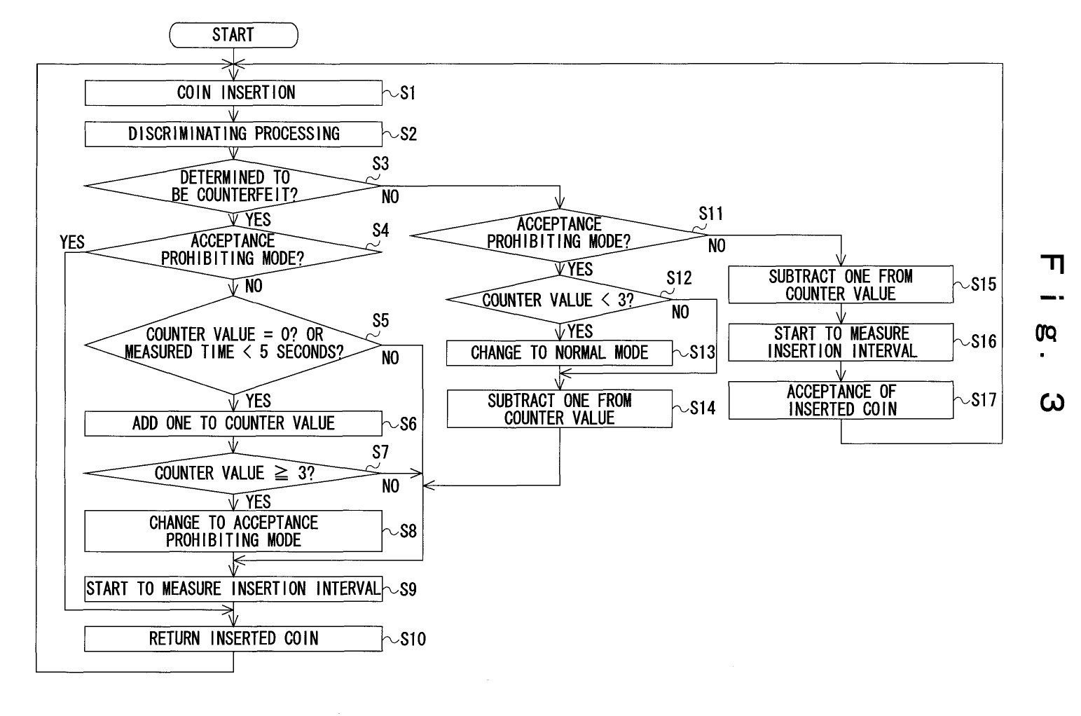

Next will be described operations at the time of inserting the coin 2 in the currency discriminating device 1 according to the embodiment with reference to a flow chart in FIG. 3.

First, when the coin 2 is inserted in the slot 11 in the normal mode (step S1), the denomination discriminating device 20 discriminates authenticity and denomination of the coin 2 passing through the coin guiding path 12 (step S2). If the denomination discriminating device 20 then determines that the coin 2 is counterfeit (step S3), the control section 110 determines whether or not the currency discriminating device 1 is operating in the acceptance prohibiting mode (step S4).

If then the currency discriminating device 1 does not operate in the acceptance prohibiting mode, and a value of the counter of the control section 110 is 0 or a time measured by the measuring section 120 is less than 5 seconds (step S5), the control section 110 increases the value of the counter by one (step S6).

Subsequently, if the value of the counter becomes not less than 3, the control section 110 changes to the acceptance prohibiting mode (step S8), and starts to measure an insertion interval of the coin 2 (step S9). In this case, since the control section 110 makes the measuring section 120 measure time after clearing the time measured by the measuring section 120, the measured time used at step S5 is indicated as the insertion interval of the coin 2. Consequently, in the embodiment, when the counterfeit coin is continuously inserted three times at less than 5-second interval, the mode is changed to the acceptance prohibiting mode, thus enabling to reduce a possibility of accepting the counterfeit coin due to continuous insertion thereof. It is to be noted that if conditions of the above-described steps S5 and S7 are not satisfied, the control section 110 performs processing of step S9.

The control section 110 then returns the inserted coin 2 by controlling the coin sorting device 30 so as to sort the inserted coin 2 into the return slot 3 (step S10). It is to be noted that if the currency discriminating device 1 is operating in the acceptance prohibiting mode at the above-described step S4, the control section 110 performs processing of step S10.

Meanwhile, if the denomination discriminating device 20 determines that the coin 2 is genuine at step S3, the control section 110 determines whether or not the currency discriminating device 1 is operating in the acceptance prohibiting mode (step S11), and if it operates in the acceptance prohibiting mode and the value of the counter is less than 3 (step S12), the mode is changed to the normal mode (step S13). In this case, when the coin 2 determined to be genuine is inserted not less than predetermined number of times until the value of the counter becomes less than 3, the mode is changed to the normal mode. Subsequently, the control section 110 subtracts one from the value of the counter (step S14), and performs processing of steps S9 and S10. Here, since the value of the counter is decreased by one at step S14 if the inserted currency is determined to be genuine, even when the acceptance prohibiting mode is canceled by processing of the above-described steps S12 and S13, when the counterfeit coin is inserted after that, the mode can be immediately changed to the acceptance prohibiting mode.

As described above, if the inserted coin 2 is determined to be genuine in the acceptance prohibiting mode, the inserted coin 2 is returned and the mode is changed to the normal mode, and thus it becomes possible to immediately accept the genuine coin 2, for example, as compared with a case where acceptance of the inserted coin 2 is prohibited until a predetermined time elapses after the mode is changed to the acceptance prohibiting mode.

In addition, if the currency discriminating device 1 is operating in the normal mode at step S11, the control section 110 subtracts one from the value of the counter (step S15), and starts to measure the insertion interval of the coin 2 (step S16). Consequently, since the value of the counter is decreased when the genuine coin is inserted, a possibility of changing to the acceptance prohibiting mode can be reduced, and reduction of sales opportunities due to the change to the acceptance prohibiting mode can be suppressed. It is to be noted that a processing content of step S15 is similar to that of step S14. Subsequently, the control section 110 accepts the inserted coin 2 by controlling the coin sorting device 30 so as to sort the inserted coin 2 into each tube 40A to 40E of the coin stacking cylinder 40 (step S17).

In the above-described flow, when a genuine coin is inserted in the acceptance prohibiting mode, the genuine coin is once returned, but change to the normal mode is performed with return processing, and thus when a genuine coin is newly inserted, it is accepted by the coin stacking cylinder 40.

As described above, with the currency discriminating device 1 according to the embodiment, included is the control device 100 in which if the inserted coin 2 is determined to be counterfeit by the denomination discriminating device 20 in the normal mode, the mode is changed to the acceptance prohibiting mode in which the coin sorting device 30 is controlled so as to return a following inserted coin 2, and in which if the inserted coin 2 is determined to be genuine by the denomination discriminating device 20 in the acceptance prohibiting mode, the coin sorting device 30 is controlled so as to return the inserted coin 2, and the mode is changed to the normal mode, so that the genuine coin 2 can be immediately accepted, for example, as compared with the case where acceptance of the inserted coin 2 is prohibited until the predetermined time elapses after the mode is changed to the acceptance prohibiting mode, thus enabling to suppress the reduction of sales opportunities to improve convenience. In addition, since the inserted coin 2 is returned in the acceptance prohibiting mode, the possibility of accepting the counterfeit coin due to continuous insertion thereof can be reduced.

In addition, the control device 100 has the counter whose value increases when the coin 2 newly inserted within the predetermined time (for example, 5 seconds) after the coin 2 is inserted is determined to be counterfeit by the denomination discriminating device 20, and when the value of the counter becomes not less than a predetermined value (for example, 3) in the normal mode, the mode is changed to the acceptance prohibiting mode, thus enabling to reduce the possibility of accepting the counterfeit coin due to continuous insertion thereof.

Further, if the inserted coin 2 is determined to be genuine by the denomination discriminating device 20, the value of the counter is decreased, and thus the possibility of changing to the acceptance prohibiting mode can be reduced, and reduction of sales opportunities due to the change to the acceptance prohibiting mode can be suppressed. In addition, even when the acceptance prohibiting mode is once canceled, when the counterfeit coin is inserted after that, the mode can be immediately changed to the acceptance prohibiting mode.

Furthermore, when the coin 2 determined to be genuine by the denomination discriminating device 20 in the acceptance prohibiting mode is inserted not less than predetermined number of times, the coin sorting device 30 is controlled so as to return the inserted coin 2, and the mode is changed to the normal mode, and thus it can be prevented to easily change to the normal mode, and such an illegal act can be prevented that, for example, making a counterfeit coin accept by continuously inserting it after inserting a genuine coin once to make the acceptance prohibiting mode cancel.

It is to be noted that the above-described embodiment is only a specific example of the present invention, and the present invention is not limited only to the above-described embodiment. For example, although the above-described embodiment deals with the coin 2 only, the present invention may be configured to be able to deal with a bill.

In addition, the control section 110 may be configured such that when the coin 2 determined to be counterfeit by the denomination discriminating device 20 in the normal mode is inserted not less than predetermined number of times (for example, three times) within a predetermined time (for example, 30 seconds) after the counterfeit coin is first inserted, the mode is changed to the acceptance prohibiting mode. In this case, similarly to the above-described embodiment, the possibility of accepting the counterfeit coin due to continuous insertion thereof can be reduced.

### INDUSTRIAL APPLICABILITY

Since a currency discriminating device of the present invention can reduce a possibility of accepting a counterfeit currency, and can suppress the reduction of sales opportunities due to the insertion of the counterfeit currency, it can be widely utilized as a currency processing machine for vending machines, etc.

1. A currency discriminating device comprising:
discriminating means that discriminates authenticity and denomination of an inserted currency;
currency sorting means that accepts the inserted currency determined to be genuine by the discriminating means, and that returns the inserted currency determined to be counterfeit by the discriminating means; and
control means that controls the discriminating means and the currency sorting means wherein
the control means
changes to an acceptance prohibiting mode in which the currency sorting means is controlled so as to return a following inserted currency if the inserted currency is determined to be counterfeit by the discriminating means in a normal mode, and controls the currency sorting means so as to return the inserted currency and changes to the normal mode if the inserted currency is determined to be genuine by the discriminating means in the acceptance prohibiting mode.

2. The currency discriminating device according to claim 1, wherein
the control means has a counter whose value increases when a currency newly inserted within a predetermined time after a currency is inserted is determined to be counterfeit by the discriminating means, and
changes to the acceptance prohibiting mode when the value of the counter becomes not less than a predetermined value in the normal mode.

3. The currency discriminating device according to claim 2, wherein if the inserted currency is determined to be genuine by the discriminating means, the control means decreases the value of the counter.

4. The currency discriminating device according to claim 1, wherein when the currency determined to be genuine by the discriminating means in the acceptance prohibiting mode is inserted not less than a predetermined number of times, the control means controls the currency sorting means so as to return the inserted currency, and changes to the normal mode.

5. The currency discriminating device according to claim 1, wherein when the currency determined to be counterfeit by the discriminating means in the normal mode is inserted not less than a predetermined number of times within a predetermined time, the control means changes to the acceptance prohibiting mode.
